(19) United States
(12) Patent Application Publication
(10) Pub. No.: US 2026/0158756 A1
(43) Pub. Date: Jun. 11, 2026

(54) System for Marking Tires During High Voltage Inspection

(71) Applicant: Shamrock Marketing, Inc., Louisville, KY (US)

(72) Inventors: Douglas B. Conley, Crestwood, KY (US); William De Andrade, Lisbon (PT)

(21) Appl. No.: 19/416,546

(22) Filed: Dec. 11, 2025

Related U.S. Application Data
(60) Provisional application No. 63/730,610, filed on Dec. 11, 2024.

(51) Int. Cl. B29D 30/00; B29D 30/54; G01N 27/02

(52) U.S. Cl. CPC B29D 30/0061; B29D 30/54; G01N 27/025; B29D 2030/546

(57) ABSTRACT

Devices and systems for identifying flaws in tires and marking the area of the flaw are described herein.

### B. CROSS-REFERENCE TO RELATED APPLICATIONS

This application claims priority from U.S. Provisional No. 63/730,610 entitled “System for Marking Tire During High Voltage Inspection” filed on Dec. 11, 2024, the contents of which are hereby incorporated by reference in their entirety.

### C. GOVERNMENT INTERESTS

Not applicable

### D. PARTIES TO A JOINT RESEARCH AGREEMENT

Not applicable

### E. INCORPORATION OF MATERIAL ON COMPACT DISC

Not applicable

### F. BACKGROUND

Retread failures occur where the rubber attaching the tread to a tire carcass does not vulcanize properly during the curing stage of the retread process. Retread failures commonly occur where the tire carcass is flawed. For example, the carcass may be punctured or cut or cables or belts may be exposed. Such injuries on the tire require further evaluation and repair before the retreading process proceeds.

A leading cause of retread failures of retread tires is missed punctures during initial inspection. Modern tire inspection devices apply a voltage to the tire that causes an arc where the tire carcass has a flaw. The operator must see the arc to know where the flaw is and mark the tire carcass accordingly. In most cases, retread failures occur because the operator missed the flaw or failed to mark the proper location of the flaw. The invention described here removes human error, and increases reliability of testing and inspecting tires for retreading by automatically marking the location of flaws in the tire carcass.

### G. SUMMARY OF THE INVENTION

Embodiments described herein include a device for marking flaws in a tire having an inspection head configured to apply a voltage to an internal surface of a tire, and an internal marking head associated with the inspection head and configured to mark the internal surface of the tire at the location of a flaw identified by the inspection head. In some embodiments, the device may further include an external marking head attached to the internal marking head and figured to mark an external surface of the tire at the location of a flaw identified by the inspection head.

A system for marking flaws in a tire having an inspection head configured to apply a voltage to an internal surface of a tire, and an internal marking head electronically connected to the inspection head and configured to mark the internal surface of the tire at the location of a flaw identified by the inspection head. In some embodiments, the system may further include an external marking head attached to the internal marking head and electronically connected to the inspection head, the external marking head being figured to mark an external surface of the tire at the location of a flaw identified by the inspection head.

### H. DESCRIPTION OF THE DRAWINGS

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in detail so as to not unnecessarily obscure the present invention.

FIG. 1 is an illustration of a tire inspecting and marking station, including an inspection head and marking head deployed to detect flaws in the tire and mark these flaws locations.

FIG. 2 is a detailed drawing of the inspection head deployed in the inner cavity of a tire carcass.

FIG. 3 is a detailed drawing of an inspection head having wire loop electrodes deployed in the inner cavity of a tire carcass with the back of the inspection head facing the reader.

FIG. 4 is a detailed drawing of a tire inspecting and marking station, showing the location of internal and external marking heads in relation to a deployed inspection head.

FIG. 5 is a detailed drawing of a marking head having an integrated inspection head and a marking head probe arm holding the marking head and the inspection head.

FIG. 6 is a detailed drawing of a marking head probe arm.

### I. DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 ml to 8 ml is stated, 2 ml, 3 ml, 4 ml, 5 ml, 6 ml, and 7 ml are also intended to be explicitly disclosed, as well as the range of values greater than or equal to 1 ml and the range of values less than or equal to 8 ml

The singular forms “a,” “an,” and “the” include plural referents unless the context clearly dictates otherwise. Thus, for example, reference to a “surfactant” includes a single surfactant as well as two or more of the same or different surfactants.

The word “about” when immediately preceding a numerical value means a range of plus or minus 10% of that value, e.g., “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entirety are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

Various embodiments of the invention are directed to devices and systems that automatically mark tires during an initial inspection where retread failures can occur before retreading. Embodiments include devices that are used during the initial inspection to automatically mark the tire carcass at locations having a flaw during the high voltage non-destructive tire inspection processes. In some embodiments, the marking apparatus may be a separate device from the high voltage inspection device, and in other embodiments the marking apparatus may be fully integrated into the high voltage inspection device. In embodiments, the tire can be marked on the inside, outside, or both the inside and outside of the tire, and in some embodiments, a non-permanent marking system can be used to remove the marks after the problem areas have been repaired. In particular embodiments, the marking system may mark the tire permanently. Other embodiments are directed to methods for using the marking apparatus to mark tire carcasses before retreading.

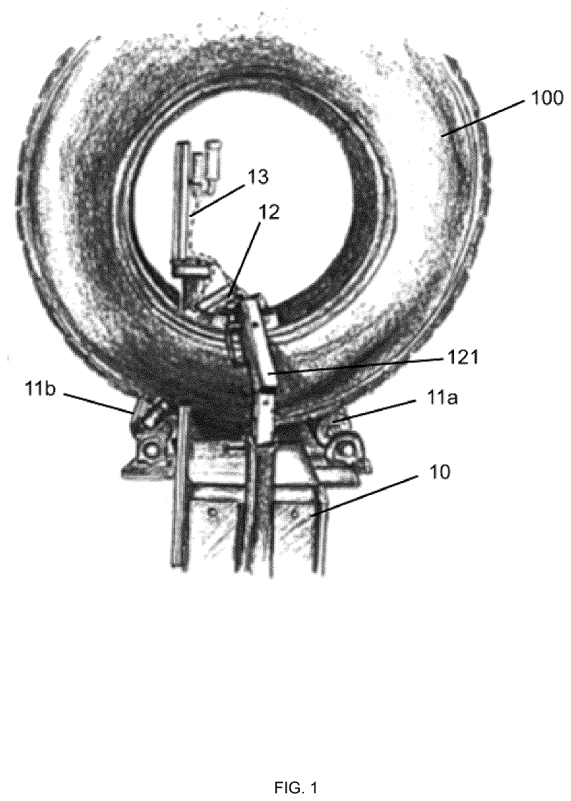

As illustrated in FIG. 1, the inspection station device 1 of various embodiments generally includes a mount 10 configured to hold and retain a tire 100 during inspection, and one or more rollers 11a, 11b positioned to contact an out surface of the tire 100. In some embodiments, a motor may be associated with one or more rollers 11a, 11b to rotate the tire 100 during inspection. In other embodiments, a roller system may include rollers that contact an upper surface of the tire and rotate the tire from an internal surface or the sidewall of the tire. An inspection head 12 may be connected to an articulating arm 121 that allows the inspection head 12 to be inserted into the tire 100. In certain embodiments, the inspection station 1 may further include an internal marking system 13 attached to the inspection head 12.

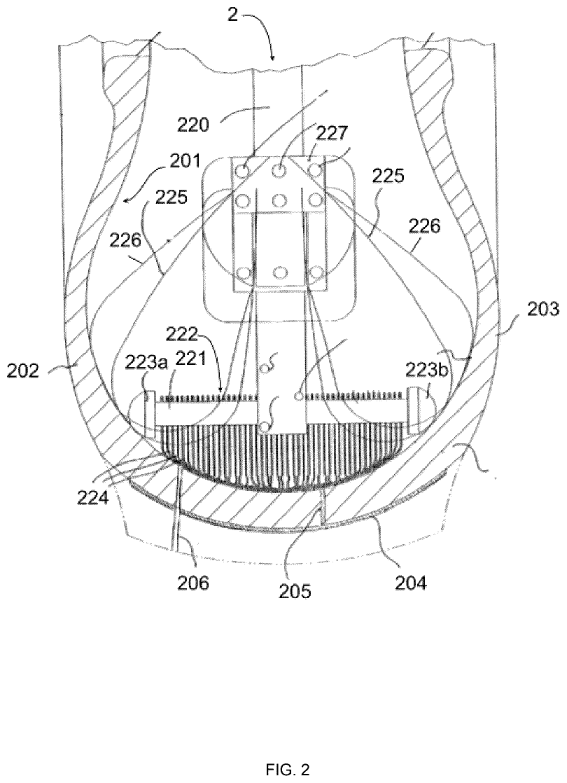

An embodiment of an inspection head 2 is illustrated in FIG. 2. The inspection head 2 may include a body 220, a high voltage electrode 221, and a grounding electrode 222 (depicted directly behind the high voltage electrode 221). Body 220 can be made from an electrically insulative material, such as non-conductive plastic. The electrodes 221, 222 may be composed of a conductive material or may contain conductive materials. In some embodiments, the electrodes 221, 222 may have wheels 223a, 223b, on one or both ends that are configured to contact tire carcass 200 to maintain the position of the electrodes 221, 220 in the tire carcass 200.

Either or both electrodes 221, 222, may have at least one probe 224 for contacting the inner liner portion 201 of a tire carcass 200. The probes 224 can be made from any electrically conductive material, and in some embodiments, the probes may be flexible chains 224 as depicted in FIG. 2. In other embodiments, the probes may be pins, wires, brushes, or any other conductive structure suitable for creating an electric field near the inner liner 201 of the tire carcass 200. The probes 224 may be spaced apart and staggered in a line or other suitable pattern along the electrodes 221, 222 to cover a substantial portion of the inner liner 201 of tire carcass 200 between sidewall portions 202, 203.

In some embodiments the inspection head 2 may include one or more laterally projecting structures 225 such as, for example, wire loops that may be attached to the body 220. The laterally projecting structures 225, 226 can be arranged to the contact sidewall 202, 203, when inspection head is inserted into the tire carcass. Each wire loop 225, 226 can be attached to the body 220 with a clamping structure 227. As illustrated in FIG. 2, a portion of the wire loops 225 are connected with high voltage electrode 221 and a portion of the wire loops 226 can be connected to the grounding electrode 222. This arrangement of electrodes 225, 226 allows an electric field to be applied to the sidewalls 202, 203 to detect flaws in the sidewalls 202, 203. The person of ordinary skill in the art will appreciate that other conductive flexible structures can be positioned for contacting sidewalls 202, 203 and can be substituted for wire loops 225, 226.

In operation, the tire carcass 200 can be positioned on rollers 11a, 11b, illustrated in FIG. 1 and inspection head 2, illustrated in FIG. 2, can be positioned between bead portions 204, 205, of the tire 200. The inspection head 2 is suspended in the inner cavity of the tire 200, and lowered until wheels 223a, 223b of the electrodes 221, 222 contact the sidewalls 202, 203 of the tire 200. In some embodiments, the electrodes 221, 222 can pivot after entering the inner cavity of the tire 200, allowing the electrodes 221, 222 to have a vertical orientation giving the inspection head 2 to have a narrow profile during insertion and an extended profile during use where the electrodes have a horizontal orientation in which the wheels 223a, 223b, and probes 224 of the electrodes 221, 222 are in contact with inner surface of tire carcass 200. Wire loops 225, 226 extend laterally to contact sidewalls 202, 203 of the tire.

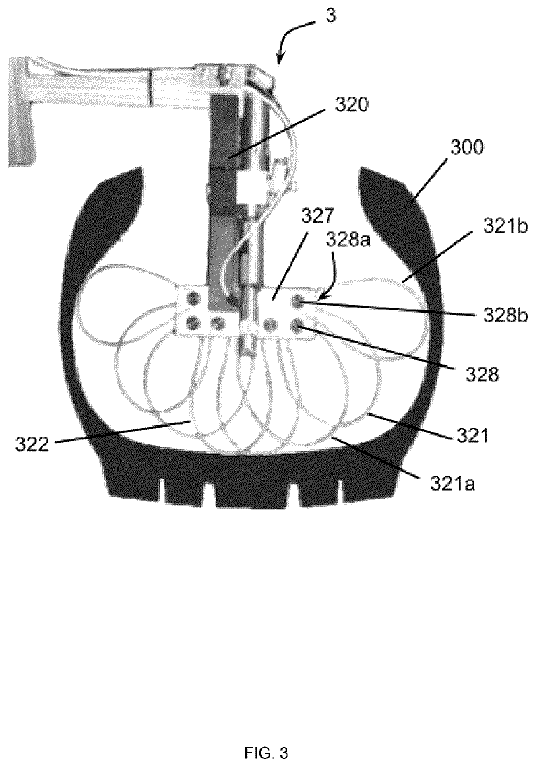

Another embodiment of the inspection head 3 is illustrated in FIG. 3. In such embodiments, the inspection head 3 may include a body 320 that can be made from an electrically insulative material, such as non-conductive plastic, a high voltage electrode 321, and a grounding electrode 322. In this embodiment, the electrodes 321, 322 may be composed of wire loops of a conductive material. Referring to FIG. 2, the person of ordinary skill in the art will appreciate that eliminating the chains 224 and wheels 223a, 223b associated with the electrodes 221, 222 reduces vibration of the body 220 and other support structures associated with inspection head 2. As such, embodiments of the inspection head 3 having wire loops 321, 322, as illustrated in FIG. 3, are more stable and accurate than inspection heads 2 having chains 224 and wheels 223a, 223b, as illustrated in FIG. 2. In addition, inspection heads 3 having wire loops 321, 322, as illustrated in FIG. 3 improve the accuracy of inspection stations incorporating the internal and external marker heads discussed below. Moreover, the flexibility of the wires adjusts to the contour of the tire allowing the inspection head 3 to accommodate tires with different levels of wear or tread depth.

The wire loops 312, 322 of embodiments illustrated in FIG. 3 can be attached to the body 320 by a clamping structure 327. In various embodiments, the number of wire loops 321, 322 incorporated into the inspection head 3 may be between 5 and 10 wire loops 321, 322 or any number or range encompassed by these numbers, and in certain embodiments, the inspection head 3 may include 8 wire loops 321, 322. The length of each wire loop may be the same for each loop or different depending on the width and depth of the internal cavity of the tire. In embodiments, the length of the loops may be about 8 inches to about 20 inches, about 10 inches to about 15 inches, or any length or range encompassed by these example ranges. This arrangement allows a wire loop to form a continuous contact area across the internal width of the tire carcass 300 and the side walls leaving no gaps. In other embodiments, the arrangement of wire loops 321, 322 can produce a gap between contact areas of the wire loops of up to about 0.75 inches without impacting the accuracy of the inspection head 3. In certain embodiments, each wire loop may be the same length and the length may be about 14 inches. In some embodiments, the number and length of the wire loops 321, 322 can be adjusted to accommodate tire sizes ranging from 14 inches to 24.5 inches in rim diameter with a single inspection head 3.

In some embodiments, the attachment points of the wire to the clamping structure may improve stability of the wire loops during contact with the tire carcass 3. For example, in some embodiments wire loops directed to the middle of the tire carcass 321a may be attached to the back of the clamping structure, contact points 328. In some embodiments, wire loops directed toward the side wall 321b may be secured to the clamping structure 327 with the one end of the wire loop attached to the front of the clamping structure, contact point 328a, and and the other end of the wire loop attached to the back of the clamping structure 327, contact point 328b. This arrangement may allow the wire loops 321a, 321b to maintain contact with the inner liner of the tire carcass at the shoulder area.

The clamping structure 227, 327 of embodiments may be composed of any material that is capable of holding the electrodes 221, 222 and wire loops 225, 226, 321, 322, including for example, conductive materials such as steel or aluminum. The contact points may be configured and machined to accept and hold the wire loops 225, 226, 321, 322 and can be composed of the same or a different conductive material. In some embodiments, acrylic sheets may be applied to each side of clamping structure 227, 327 to hold the wire loops 225, 226, 321, 322 in place.

In use, when the probes 224 and wire loops 225, 226, 321, 322 of the inspection head 2, 3 are positioned in tire carcass 200, 300, high voltage is applied to high voltage electrode 221 or wire loops 321, thereby creating an electrical field about high voltage electrode 221 or wire loops 321. A rotary drive motor rotates rollers 11a, 11b, causing tire carcass 200, 300 to rotate. The probe chains 224 and wire loops 225, 226 or the wire loops 321, 322 slide along the inner liner of the tire carcass 200, 300 applying the electrical field from high voltage electrode 221, 321 to the inner liner of the tire carcass 200, 300. Inductive coupling takes place between the steel belts 204 of the tire carcass 200, producing an electrical potential with respect to grounding electrode 222, as illustrated in FIG. 2. When the probes 224 and wire loops 225, 226 contact a flaw in the tire, such as inner liner defect 205 or through hole 206, an arc passes through the flaw between the steel belts 204 and the probes 224 and wire loops 225, 226, indicating the presence of the flaw. Once a complete rotation of tire carcass 200 has been made the inspection head 2 can be removed from the tire carcass 200 and the inspection head 2 can be prepared to test another tire. This same process occurs for inspection heads 3 having wire loops 321, 322.

The person of ordinary skill in the art will appreciate that the only part of the insertion head 3 of FIG. 3 that will contact the inner liner of the tire carcass 300 is the wire loops 321, 322 when the insertion head is deployed. The body 320 and clamping device 327 that supports the wire loops 321, 322 is “floating” over the tire, eliminating any vibration generated on the traditional chain and wheel system illustrated in FIG. 2. Additionally, the flexibility of the wires adjusts to the contour of the tire and also to multiple heights to accommodate tires at different levels of wear or tread depth.

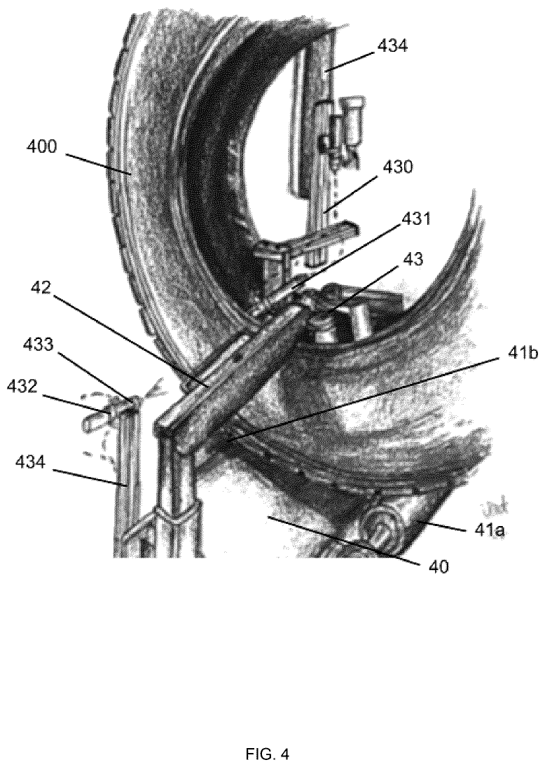

In some embodiments, the arc caused by a flaw in the tire carcass may cause the rotary motor to stop by the action of a current transformer that detects the change in potential caused by the arc and turns the rotary motor off. The operator must see the arc to locate the flaw and is required to hand mark the location of the flaw. In particular embodiments, marking can be carried out automatically using the device illustrated in FIG. 4.

FIG. 4 shows an inspection head deployed in the cavity of a tire carcass 400 during tire testing. The rollers 41a, 41b and mount 40 are illustrated engaging a tire carcass 400 articulating arm 42 is holding the inspection head 43 in place in the cavity of the tire carcass 400. The marking system may include an internal marking head 430 equipped with an internal marker 431 and an external marking head 432 equipped with an external marker 433. A support structure 434 connects to the internal marking head 430 and external marking head 432 maintaining their position relative to one another such that marking occurs on the inner liner of the tire carcass 400 and the external side wall of the tire carcass at the same position.

In some embodiments, the internal marking head 430 and the external marking head 432 may be electrically connected to a current transformer associated with the inspection head 43. In operation, the internal marking head 430 and the external marking head 432 can be triggered when the current transformer detects a flaw in the tire causing the internal marker 431 and the external marker 433 to mark the inner liner 401 and the external sidewall 402 of the tire carcass 400 at the location of the flaw.

In some embodiments, the internal marking head 430 and the external marking head 432 may be connected to one or more amplifiers, resistors, relays, printed circuit boards, and the like and combinations thereof that increase the magnitude of the current transformer signal. In some embodiments, the internal marking head 430 and the external marking head 432 may be connected to one or more optical sensors positioned to detect the arc generated by a flaw in the tire carcass and trigger the internal and external markers 431, 433 to mark the tire carcass 400. In certain embodiments, the internal marking head 430 and the external marking head 432 may be connected to a printed circuit board (“PCB”) designed to measure a change in voltage. Such PCB may include, for example, a voltage divider circuit to scale the input voltage to a suitable range, an analog-to-digital converter to convert the analog voltage signal to a digital value that can be read by a microcontroller, and necessary circuitry to handle the specific voltage range and desired accuracy of the measurement. The PCB may enhance the signal from the current transformer improving the accuracy of the internal and external marking heads.

In some embodiments, the PCB, amplifiers, resistors, relays, and the like may be integrated into a programmable logic controller (“PLC”) to fully automate the marking process by coordinating the inspection head 43, rotary motor, and internal and external marking heads 430, 432. For example, in some embodiments, the PLC may cause the rotary motor to stop when a flaw is detected, pausing the inspection process. This pause may be carried out for sufficient time for the PCB to reset itself before the PLC causes the inspection head 43, rotary motor, and internal and external marking heads 430, 432 to resume the test. In some embodiments, the PLC may delay marking until the inspection process is paused. When the markers react immediately after a flaw is detected, marks can be smeared; however, delaying marking too long causes smearing as the tire resumes rotation before the marking is complete. In further embodiments, the PLC may reduce the occurrence of errant marking during the activation process.

The internal and external markers 431, 433 can be configured to mark the tire using any method known in the art, including, for example, sprayers, dabbers, stampers, dot peen markers, pad printers, lasers, and the like and combinations thereof. For example, in some embodiments, the external marker 433 can be a sprayer to mark the external surface of the side wall of the tire carcass 400, and the internal marker 431 may be a dabber. In such embodiments, the internal marker 431 may include dabber or stamp attached to a piston or actuator that moves the dabber or stamp relative to the internal liner of the tire carcass 400. When the piston or actuator is activated the dabber or stamp may be moved toward the internal liner until contact is made transferring ink or paint on the dabber or stamp onto the internal liner at the location of a flaw. In some embodiments, the internal and external markers 431, 433 may further include a reservoir containing ink or paint that replaces ink transferred to the internal liner by the dabber, stamp, or sprayer and the external sidewall of the tire carcass 400. In other embodiments, an external reservoir may feed ink or paint to the internal and external markers 431, 433. In such embodiments, the reservoir may be pressurized, and in some embodiments, the reservoir may be self-cleaning to avoid clogging of the internal and external markers 431, 433.

Any ink or paint known in the art can be used by the internal and external markers 431, 433 to mark the tire carcass 400. In certain embodiments, the ink or paint may be water based to avoid inadvertently igniting the ink or paint when high voltage is applied to the marked area.

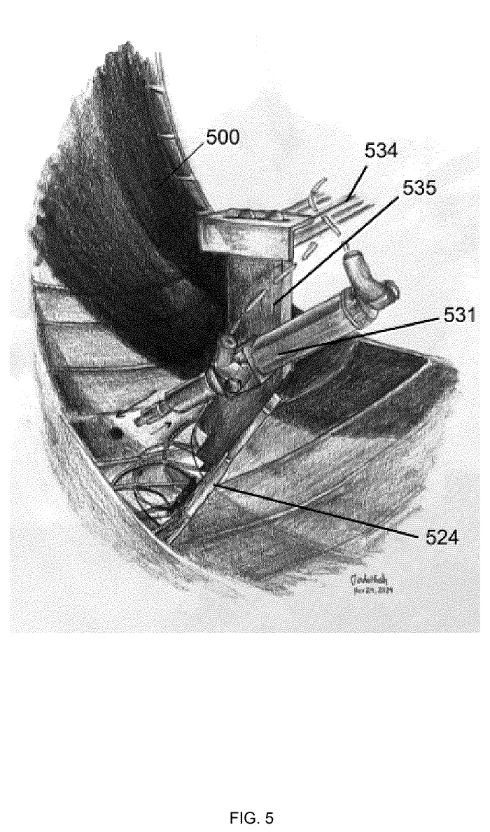

The internal marking head 530 is illustrated in FIG. 5 deployed in a tire carcass 500. The marking head 530 includes an internal marker 531 attached to a marking head probe arm 535 connecting the internal marker 531 to support structure 534. In some embodiments, the marking head may be separate and apart from the inspection head (not shown). In other embodiments, as illustrated in FIG. 5, the probe 524 portion of the inspection head may be attached to the marking head probe arm 535. The person of ordinary skill in the art will appreciate that a marking head 530 with an integrated inspection head probe 524 may reduce the number and overall size of the components deployed during tire inspection, improving mobility of these components.

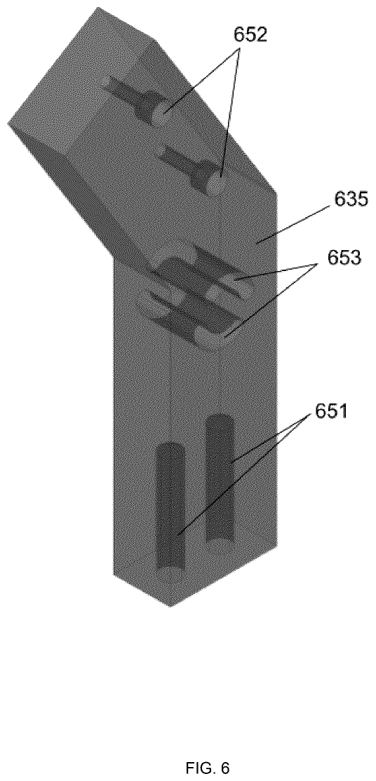

The marking head probe arm 535 of embodiments may include an integrated means for attaching the marking head probe arm 535 to the support structure 534 and the inspection head probe 524. As illustrated in FIG. 6, the marking head probe arm 635 may include, for example, tapped holes 651 configured to receive a screw or bolt or recesses 652 configured to receive a fastener, for attaching the inspection head probe to the marking head probe arm 635 and the marking head probe arm 635 to the support structure. In some embodiments, the internal marker can be attached to marking head probe arm 635 using tapped holes. In other embodiments, the marking head probe arm 635 may include slotted holes or arc slots 653 that allow the internal marker to pivot, allowing the operator to align the internal marker relative to the inspection head probe to avoid interference with the detection device. The marking head probe arm 635 may be composed of any suitable material such as, for example, steel, aluminum, plastic, nylon, teflon, and the like or combinations thereof.

Among other benefits, including reducing the size the of the inspection and marking apparatuses and ease of deployment, associated with the use of a marking head probe arm having both the marking head probe 531 and the probe 524 portion of the inspection head, is reduction on vibration on the probes as the tire rotates during the inspection process. In many prior art devices the inspection head is directly attached to the mount, which also holds the rollers. As the rollers rotate the tire the inspection head vibrates. Reducing or eliminating vibration of the inspection head by attaching it to a support structure that is not attached to the mount improves the precision of the inspection head making marking more accurate and reducing the time required to repair the identified flaws. In the context of the electrode and chain embodiments, as illustrated in FIG. 1, reducing vibration associated with direct attachment of the inspection head to the mount reduces or eliminates incidents of false positives caused by the multiple arcs caused by the same flaw when more than one chain is dragged over the same flaw.

The device and system discussed above significantly reduces the time required to perform high voltage inspection of tire carcasses while reducing the number of flaws missed by visual inspection and the overall incidence of retread failures. In some embodiments, the system may perform the inspection process described above and mark the areas of interest in under 45 seconds for up to four injuries. In other embodiments, the system may perform the inspection process described above and mark the areas of interest in under 30 seconds for up to four injuries. Thus, the devices and systems of various embodiments described above may perform tire inspection and marking about 2 to about 4 or about 5 times faster than a human performing the same task.

1. A device for marking flaws in a tire, the device comprising:
an inspection head at least having:
a body;
a high voltage electrode positioned to apply a voltage to an internal surface of a tire; and
a grounding electrode;
an internal marking head in communication with the inspection head and positioned to mark the internal surface of the tire at the location of a flaw in the tire.

2. The device of claim 1, wherein the high voltage electrode further comprises a probe positioned to contact the internal surface of the tire.

3. The device of claim 2, wherein the probe is selected from the group consisting of pins, wires, brushes, or a conductive structure suitable for creating an electric field near the internal surface of the tire.

4. The device of claim 2, wherein the probe covers a substantial portion of an inner liner of the internal surface of the tire between sidewall portions of the internal surface of the tire.

5. The device of claim 1, further comprising laterally projecting structures positioned to contact a sidewall portion of the internal surface of the tire, wherein at least a portion of the laterally projecting structures are electrically connected to the high voltage electrode and at least a portion of the laterally projecting structure are electrically connected to the grounding electrode.

6. The device of claim 5, wherein the laterally projecting structures comprise flexible wire loops.

7. The device of claim 1, wherein the internal marketing head is selected from the group consisting of sprayers, dabbers, stampers, dot peen markers, pad printers, and combinations thereof.

8. The device of claim 1, wherein the device further comprises an external marking head electronically connected to the internal marking head and positioned to mark an external surface of the tire at the location of a flaw identified by the inspection head.

9. The device of claim 8, further comprising a support structure operably connecting the body and the internal marking head and the external marking head, the support structure being configured to maintain the position of the internal marking head and the external marking head relative to one another such that marking occurs on the internal surface of the tire and the external surface of the tire at substantially the same position on the tire.

10. The device of claim 1, wherein the external marking head is selected from the group consisting of sprayers, dabbers, stampers, dot peen markers, pad printers, and combinations thereof.

11. The device of claim 1, further comprising one or more amplifiers, resistors, relays, printed circuit boards, and combinations thereof.

12. The device of claim 1, comprising a printed circuit board comprising one or more voltage divider circuits, one or more analog-to-digital converter, one or more microcontroller, and combinations thereof.

13. The device of claim 1, further comprising a programmable logic controller electronically connected to one or more amplifiers, resistors, relays, printed circuit boards, and combinations thereof.

14. The device of claim 1, further comprising one or more optical sensors positioned to detect an arc generated at a flaw in the tire.

15. The device of claim 1, further comprising a support structure operably connecting the body and the internal marking head and configured to maintain the position of the internal marking head on the internal surface of the tire.

16. The device of claim 1, further comprising a mount and rollers configured to engage the tire and rotate the tire during operation of the device.

17. A device for marking flaws in a tire, the device comprising:
an inspection head at least having:
a body;
a high voltage electrode positioned to apply a voltage to an internal surface of a tire; and
a grounding electrode;
an external marking head in communication with the inspection head and positioned to mark the external surface of the tire at the location of a flaw in the tire.

18. A system for marking flaws in a tire, the device comprising:
an inspection head configured to apply a voltage to an internal surface of a tire; and
an internal marking head electronically connected to the inspection head and configured to mark the internal surface of the tire at the location of a flaw identified by the inspection head.

19. The system of claim 3, wherein the system further comprises an external marking head attached to the internal marking head and electronically connected to the inspection head, the external marking head being figured to mark an external surface of the tire at the location of a flaw identified by the inspection head.

20. An inspection head for identifying flaws in a tire, comprising:
a body;
a clamping structure attached to the body; and
5 to 10 wire loops extending from and attached to the clamping structure, the wire loops being configured and arranged to contact the inner liner of the tire during the inspection process.
